(19) United States
(12) Patent Application Publication
(10) Pub. No.: US 2015/0310103 A1
(43) Pub. Date: Oct. 29, 2015

(54) SYSTEM FOR ACCESSING THE FULL OR SELECTED PERSONAL DETAILS OF AN INDIVIDUAL USING A ZIPREG NUMBER AND METHOD OF USING SAME

(71) Applicant: ANTHONY ABIOLA JOHNSON, LAGOS (NG)

(72) Inventor: ANTHONY ABIOLA JOHNSON, LAGOS (NG)

(21) Appl. No.: 14/262,754

(22) Filed: Apr. 27, 2014

(51) Int. Cl. G06F 17/30

(52) U.S. Cl. CPC G06F 17/30864

(57) ABSTRACT

A system for accessing the full or selected personal detail information of an individual, which includes an individual computer for storing a ZIPREG number, a ZIPREG computer for storing personal contact detail information about an individual and for creating and providing the ZIPREG number to the individual, a requester computer such that the individual computer, the ZIPREG computer and requester computer are operatively connected to each other, and means for the requester computer to request the ZIPREG number from the individual computer in order for the requester computer to obtain the personal contact detail information about the individual from the ZIPREG computer.

### FIELD OF THE INVENTION

This invention relates generally to a system for accessing the full or selected personal detail information of an individual, which includes an individual computer for storing a ZIPREG number, a ZIPREG computer for storing personal contact detail information about an individual and for creating and providing the ZIPREG number to the individual, a requester computer such that the individual computer, the ZIPREG computer and requester computer are operatively connected to each other, and means for the requester computer to request the ZIPREG number from the individual computer in order for the requester computer to obtain the personal contact detail information about the individual from the ZIPREG computer.

### BACKGROUND OF THE INVENTION

Prior to the present invention, as set forth in general terms above and more specifically below, it is known, to employ a system that includes the capability of using various authentication mechanisms to share a first party's (user's) personal information stored in a server computer connected to the Internet with a second party (requester). The authentication mechanisms may include a biometric identifier, a single-use password, an expiration time on a password, or permit a second party (requester) to access authorized portions of a first party's (user's) information from an on-line database. See for example, U.S. Pat. No. 8,310,510 to Boesch, U.S. Pat. No. 8,495,485 to Rundle, U.S. Pat. No. 8,589,440 to Chaganti et al., U.S. Pat. No. 8,600,931 to Wehrle et al., U.S. Pat. No. 8,620,778 to Malkareddy, U.S. Pat. No. 8,645,424 to Miller, U.S. Pat. No. 8,656,274 to Kashi, U.S. Patent Application 2012/0253849 to Parker et al., and U.S. Patent Application 2013/0341391 to Vellozo Luz et al., While the use of authentication mechanisms permit a second party (requester) to access authorized portions of a first party's (user's) personal contact detail information from an on-line database may have been generally satisfactory, there is nevertheless a need for an on-line system for accessing the full or selected personal contact details of the user whose personal contact details are required by the requester that provides universal, instant access to the user's personal contact detail information in an errorless, paperless manner, such that the user's personal contact detail information can be quickly and easily retrofitted into the requestor's on-line personal contact detail form and/or database.

It is a purpose of this invention to fulfill this and other needs in the art in a manner more apparent to the skilled artisan once given the following disclosure.

### SUMMARY OF THE INVENTION

A feature of the present invention is a system for accessing the full or selected personal detail information of an individual, which includes an individual computer for storing a ZIPREG number, a ZIPREG computer for storing personal contact detail information about an individual and for creating and providing the ZIPREG number to the individual, a requester computer such that the individual computer, the ZIPREG computer and requester computer are operatively connected to each other, and means for the requester computer to request the ZIPREG number from the individual computer in order for the requester computer to obtain the personal contact detail information about the individual from the ZIPREG computer.

Another feature of the present invention is the provision of a system, wherein the individual computer means includes a browser means, and an individual computer data storage means operatively connected to the browser means.

Another feature of the present invention is the provision of a system, wherein the individual computer data storage means includes a means for storing a ZIPREG number; and a means for storing the personal contact detail information about the individual.

Another feature of the present invention is the provision of a system, wherein the individual computer means includes a means for inputting information into the individual computer; and a means for displaying information to the individual.

Another feature of the present invention is the provision of a system, wherein the ZIPREG computer means includes a ZIPREG server means, a ZIPREG computer data storage means operatively connected to the ZIPREG server means, and a means for storing information about the requester.

Another feature of the present invention is the provision of a system, wherein the ZIPREG computer data storage means includes a means for creating and storing a ZIPREG number, a means for storing the personal contact detail information about the individual, a means for storing a personal identification number that is unique to the individual.

Another feature of the present invention is the provision of a system, wherein the requester computer means includes a requester server means, a requester browser means, and a requester computer data storage means such that the requester server means: the requester browser means and requester computer data storage means are operatively connected to each other.

Another feature of the present invention is the provision of a system, wherein the requester computer data storage means includes a means for storing the ZIPREG number, and a means for storing the personal contact detail information about the individual.

A further feature of the present invention is the provision of a method for accessing the full or selected personal detail information of an individual, wherein the method includes the steps of entering personal contact detail information about an individual into a ZIPREG server in order to create a ZIPREG number that corresponds to the individual's personal contact detail information; providing the ZIPREG number by the individual to a requester; and allowing the requester to gain access to the personal contact detail information about the individual by utilizing the ZIPREG number.

Another feature of the present invention is the provision of a method, wherein the step of entering personal contact detail information about an individual in order to create a ZIPREG number that corresponds to the individual's personal contact detail information includes the steps of using a ZIPREG computer means to create a personal contact detail information for the individual, using the ZIPREG computer means to check the individual's personal contact detail information to determine if the individual's personal contact detail information is substantially sufficient, using the ZIPREG computer means to provide a ZIPREG number to the using the ZIPREG computer means to assign a personal identification number to the individual, and using the ZIPREG computer means to confirm with the individual that the individual has desired to obtain a ZIPREG number.

Another feature of the present invention is the provision of a method, wherein the step of using a ZIPREG computer means to create a personal contact detail information for an individual further includes the steps of using the ZIPREG computer means to create an user name for the individual, and using the ZIPREG computer means to create a password for the individual.

Another feature of the present invention is the provision of a method, wherein the step of using a ZIPREG computer means to create a personal contact detail information for an individual further includes the step of means for editing the personal contact detail information for the individual.

Another feature of the present invention is the provision of a method, wherein the step of using the ZIPREG computer means to confirm with the individual that the individual has desired to obtain a ZIPREG number further includes the steps of means for notifying the individual that a ZIPREG number has been established for the individual, means for the individual to acknowledge that the individual has requested a ZIPREG number, and means for the individual to accept various terms and conditions for usage of the ZIPREG number.

Another feature of the present invention is the provision of a method, wherein the step of providing the ZIPREG number by the individual to a requester further includes the steps of using a ZIPREG computer means to create an user name for the requester, using the ZIPREG computer means to create a password for the requester, and establishing security and information privacy credentials of the requester.

Another feature of the present invention is the provision of a method, wherein the step of providing the ZIPREG number by the individual to a requester further includes the steps of requesting a ZIPREG number from the individual by the requester, and transmitting the ZIPREG number from the individual to the requester.

Another feature of the present invention is the provision of a method, wherein the step of allowing the requester to gain access to the personal contact detail information about the individual by utilizing the ZIPREG number further includes the steps of transmitting the ZIPREG number from the requester to a ZIPREG server means, using the ZIPREG server means to authenticate the ZIPREG number, and transmitting the personal contact detail information of the individual to the requester.

A further feature of the present invention is the provision of at least one non-transitory computer-readable medium storing computer-readable instructions that when executed by a computing device, cause the computing device to enter personal contact detail information about an individual into a ZIPREG server in order to create a ZIPREG number that corresponds to the individuals personal contact detail information, provide the ZIPREG number by the individual to a requester, and allow the requester to gain access to the personal contact detail information about the individual by utilizing the ZIPREG number.

Another feature of the present invention is the provision of at least one non-transitory computer-readable medium storing computer-readable instructions, wherein the step of entering personal contact detail information about an individual in order to create a ZIPREG number that corresponds to the individual's personal contact detail information further includes the steps of using a ZIPREG computer means to create a personal contact detail information for the individual, using the ZIPREG computer means to check the individual's personal contact detail information to determine if the individual's personal contact detail information is substantially sufficient, using the ZIPREG computer means to provide a ZIPREG number to the individual, using the ZIPREG computer means to assign a personal identification number to the individual, and using the ZIPREG computer means to confirm with the individual that the individual has desired to obtain a ZIPREG number.

A further feature of the present invention is the provision of at least one first computing device for controlling utilization of content, the at least one first computing device including: one or more processors; and one or more memories operatively coupled to at least one of the one or more processors and having instructions stored thereon that, when executed by at least one of the one or more processors, cause at least one of the one or more processors to enter personal contact detail information about an individual into a ZIPREG server in order to create a ZIPREG number that corresponds to the individuals personal contact detail information, provide the ZIPREG number by the individual to a requester, and allow the requester to gain access to the personal contact detail information about the individual by utilizing the ZIPREG number.

Another feature of the present invention is the provision of at least one first computing device for controlling utilization of content, wherein the step of entering personal contact detail information about an individual in order to create a ZIPREG number that corresponds to the individual's personal contact detail information further includes the steps of using a ZIPREG computer means to create a personal contact detail information for the individual, using the ZIPREG computer means to check the individual's personal contact detail information to determine if the individual's personal contact detail information is substantially sufficient, using the ZIPREG computer means to provide a ZIPREG number to the individual, using the ZIPREG computer means to assign a personal identification number to the individual, and using the ZIPREG computer means to confirm with the individual that the individual has desired to obtain a ZIPREG number.

The preferred system for accessing the full or selected personal detail information of an individual, according to various embodiments of the present invention, offers the following advantages: ease of use, economy of design, universal and instant access to the user's personal contact detail information in an errorless, paperless manner, and the ability to quickly and easily retrofit the user's personal contact detail information into the requestor's on-line personal contact detail form and/or database.

### BRIEF DESCRIPTION OF THE DRAWINGS

The above mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a schematic illustration of a system for accessing the full or selected personal details of an individual using a ZIPREG number, constructed according to the present invention;

FIG. 2 (FIGS. 2A and 2B) is a flowchart illustrating a sub-routine for obtaining a user ZIPREG number and editing the user's personal contact detail sheet (CDS) information by the user, according to the system of FIG. 1;

FIG. 3 is a flowchart illustrating a sub-routine for creating an account by the requester so that the requester is able to access the ZIPREG numbers, according to the system of FIG. 1;

FIG. 4 is a flowchart illustrating a sub-routine for providing ZIPREG number information by the user to the requester, according to the system of FIG. 1; and

FIG. 5 (FIGS. 5A and 5B) is a flowchart of a sub-routine for providing user personal CDS information to the requester by utilizing the ZIPREG number, according to the system of FIG. 1.

### DETAILED DESCRIPTION OF THE PREFERRED EMBODIMENTS

To provide some perspective that will be helpful in understanding and appreciating the inventive concepts of the present invention, it is well known that many companies utilize on-line forms that must be populated with personal contact detail data. For example, when a person desires to join a frequent flyer club, that person is required to enter certain personal contact detail information such as name, address, telephone contact(s), travel preferences and the like. If that same person desires to join several frequent flyer clubs, the person will be required to enter substantially the same personal contact detail information for each and every frequent flyer club, which can become very tedious for that person. Also, there is a good probability that the person will not enter the required personal contact detail information correctly for each frequent flyer club. If the person desires to join an organization that requires even more detailed personal contact information such as a health provider network, then the person may have to enter this greater amount of personal contact detail information several times which could result in an even greater likelihood that the personal contact detail information will be entered incorrectly. The present invention can be used to reduce the number of times that a person has to enter personal contact detail information into an on-line personal contact detail information form while substantially reducing the likelihood that the personal contact detail information was entered into the on-line personal contact detail information form incorrectly.

The present invention addresses the need for an on-line system for accessing the full or selected personal contact details of the user whose personal contact details are required by the requester wherein the system provides universal, instant access to the user's contact detail information in an errorless, paperless manner, such that the users contact detail information can be quickly and easily retrofitted into the requestor's on-line personal contact detail form and/or database.

The following detailed description is organized and arranged according to the following outline:

(A) SYSTEM HARDWARE

(B) SYSTEM OPERATION

(C) SYSTEM COMPUTER SOFTWARE

The detailed description will commence with a description of the system hardware.

### (A) System Hardware

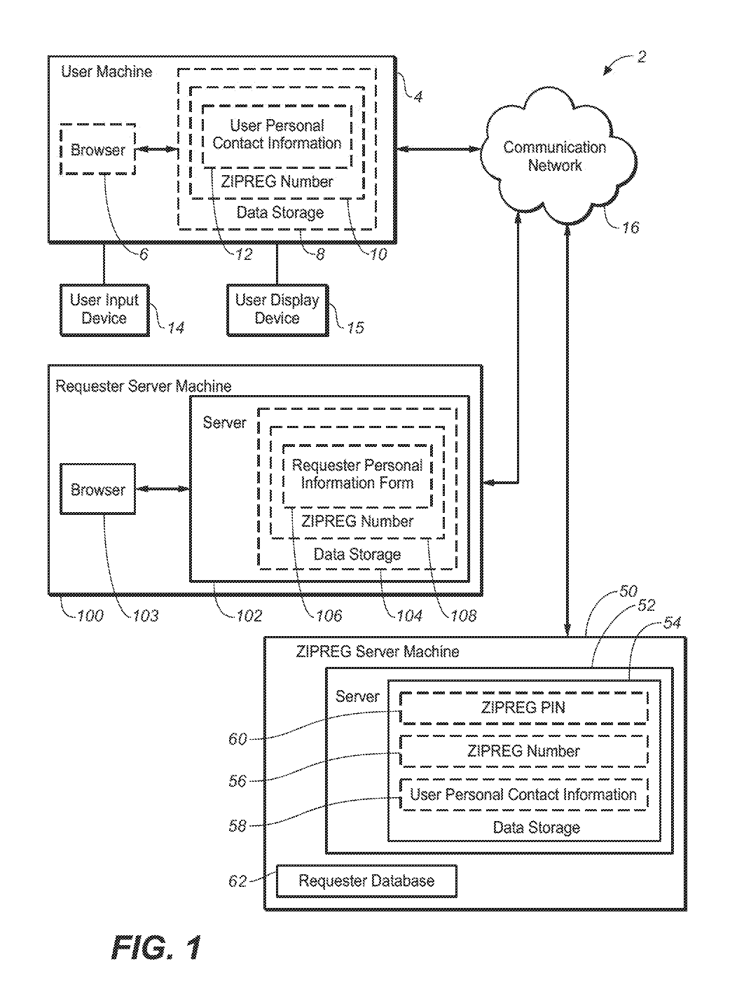

Consider now client-server system 2 in greater detail with reference to FIG. 1. FIG. 1 provides an architectural diagram illustrating a client-server system 2. Client-server system 2 includes a user machine 4, ZIPREG server machine 50, and requester server machine 100 connected via communication network 16. It is noted, however, that client-server system 2 may include more than one user machine and one or more server machines.

User machine 4 includes browser 6, data storage module 8, user input device 14 (e.g., a keyboard), and display device 15 (e.g., a CRT monitor). It is noted that the data storage module 8 may represent any type of data storage device that is capable of storing data related to a ZIPREG number and the user's personal contact information.

ZIPREG server machine 50 includes server 52 and requester data storage module 62. Server 52 can respond to receiving an appropriate request (over communications network 16) from browser 6 by serving to browser 6 a ZIPREG number stored in ZIPREG number data storage module 56 such that the ZIPREG number is associated with the user's personal contact information that is stored in the user's personal contact information data storage module 58. Server 52 can also respond to receiving an appropriate request (over communications network 16) from browser 103 by serving to browser 103 the user's personal contact information stored in user personal contact information data storage module 58 such that the user's personal contact information is associated with the ZIPREG number that browser 103 forwards to server 52. Requester data storage module 62 can be used to store information about the requester(s).

Requester server machine 100 includes server 102 and browser 103. Server 102 can respond to receiving a request from browser 6 by serving to browser 6 a requester's personal contact information form stored in the requester's personal information form storage module 106. The requester's personal information form requires the user's ZIPREG number in order to populate the needed personal contact detail information. As discussed above, server 52 can respond to receiving an appropriate request (over communications network 16) from browser 103 by serving to browser 103 a user's personal contact information stored in user personal contact information data storage module 58 such that the user's personal contact information 58 is associated with the ZIPREG number that browser 103 forwards to server 52.

It is to be understood that client-server system 2 may be any type of computing device that allows the user to interact with other server machines and to perform the functions that are described below. For example, the user machine 4, ZIPREG server machine 50, and requester's server machine 100 may be a personal computer that runs a local operating system, such as a version of MICROSOFT WINDOWS, NT, UNIX or Linux, etc. It is to be further understood that the user machine 4, as well as each one of the other server machines 50 and 100, may be located on geographically different premises. As discussed above, the user machine 4, ZIPREG server machine 50, and requester's server machine 100 communicate with one another via communications network 16, or other suitable means of communication. Alternatively, information can be stored in various different forms of memory media, such as a removable flash memory card, and physically transported to the receiving computer.

It is to be understood that communication link 16 may represent a network, a series of networks, a wireless network(s), the Internet, or any combination thereof.

### (B) System Operation

In operation, assume that a user/patient is interested in obtaining the services of a physician to conduct a particular surgical procedure and the user/patient needs to provide the physician/requester with personal contact detail information about the user/patient so that the physician can obtain some of the personal contact detail information needed to determine if the user/patient is a suitable candidate for the surgical procedure, which is implemented by the system 2 in FIG. 1.

As shown in FIG. 1, the user/patient utilizes the user input device 14 and browser 6 of user machine 4 to access ZIPREG server 52 of ZIPREG server machine 50 through communication network 16. As will be explained in greater detail later, the user/patient sets up an account in data storage module 54 and provides the required personal contact detail information which will stored in the user's personal contact information data storage module 58. An example of personal contact detail information that may be provided by the user is, but not limited to:

### Example of Personal Contact Detail Sheet (CDs) Information

### Block A: Profile

### Name

Title
First Name
Middle Name
Last Name
Surname
Former Name(s)

### Sex

### Marital Status

### Religion

### Ethnicity

### Address(es)

Home Address
Business Address

### Contact Information

Home Telephone Number
Work Telephone Number
Mobile Telephone Number
E-mail address

### Date of Birth

### Place of Birth

### Nationality

### Block B: Family Details

### Spouse/Domestic Partner Name

First Name
Middle Name
Last Name

### Children(s) Name(s)

First Name(s)
Middle Name(s)
Last Name(s)

### Next of Kin

First Name(s)
Middle Name(s)
Last Name(s)
Address(es)
Telephone Number(s)

### Block C: Travel Information

### Passport Information

### Frequent Flyer Information

### Hotel Information

### Rental Car Information

### Block D: Photograph

### Block E: Work Details

### Profession

### Present Occupation

### Company Name

### Company Address

### Work Telephone Number

### Work E-mail

### Block F: Educational Details

### Secondary School

### High School

### College

### Post-Graduate School

### Qualifications/Licenses

### Block G: Social Details

### Favorite Pet

### Favorite Food

### Favorite Music

### Favorite Sport

### Favorite Movie

If the user/patient personal contact detail information is acceptable to server 52, then the user/patient is assigned a unique ZIPREG number that is associated with that particular user/patient and the user/patient's personal contact information which is stored in the ZIPREG number data storage module 56. The user/patient is able to view the ZIPREG number on the user display device 15 and store the ZIPREG number, along with the user/patient personal contact detail information in the ZIPREG number data storage module 10 and the user's personal contact information data storage module 12, respectively.

After the user/patient has been assigned a ZIPREG number, the user/patient then utilizes the user input device 14 and browser 6 of user machine 4 to access requester server 102 of requester server machine 100 through communication network 16. As will be explained in greater detail later, the requester will send a request to the user for the user's ZIPREG number by sending the request from browser 103 to user machine 4. If the user/patient decides to share the user/patient personal contact information with the physician/requester, the user/patient merely has to send the user/patient ZIPREG number to the requester such as thorough various suitable communication means, such as, but not limited to, an electronic text message, an e-mail, a telephone call, a hard copy letter or the like. Typically, the user would electronically send the user/patient ZIPREG number from the ZIPREG number data storage module 10 to the requester's server 102. The user/patient ZIPREG number is then placed in the ZIPREG number data storage module 108 of data storage module 104.

Once the user/patient ZIPREG number is placed in requester server 102, the requester server machine 100 utilizes browser 103 to access ZIPREG server 52 of ZIPREG server machine 50 through communication network 16. As will be explained in greater detail later, if the requester/physician has previously set up an account with server 52, the requester/physician merely has to provide server 52 with the user/patient ZIPREG number from ZIPREG number data storage module 108 and the user/patient's personal contact detail information will be electronically forwarded to the requester/physician from user's personal contact information module 58 to the requester's personal information form module 106. Afterwards, the requester's personal information form will be populated with the user/patient's personal contact detail information. In this manner, the patient/user is able to securely and efficiently provide the user's/patient's personal contact information to several requesters/physicians without having to fill out numerous forms. Also, the user/patient is less likely to provide inaccurate information to the requester/physician. Finally, the user/patient has complete control over which requester/physician gets access to the user/patient personal contact information by controlling which requester/physician has access to the user's ZIPREG number.

### (C) System Computer Software

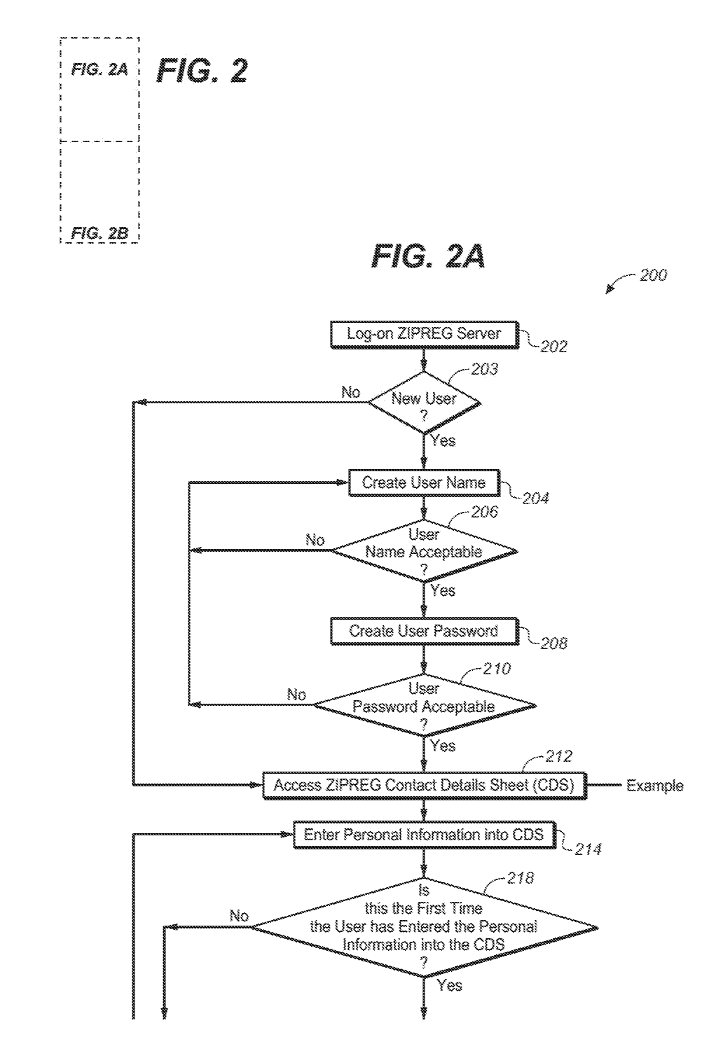

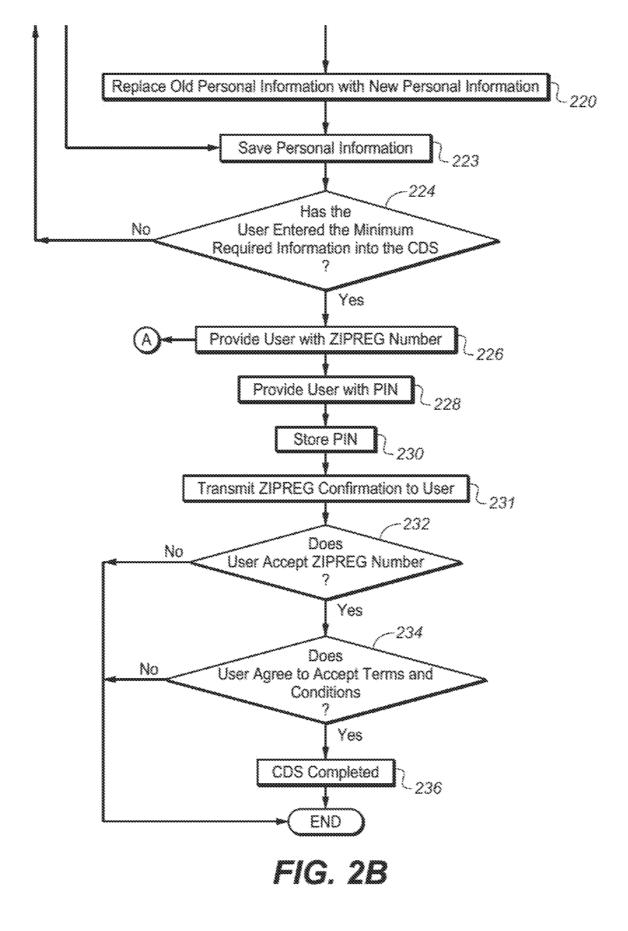

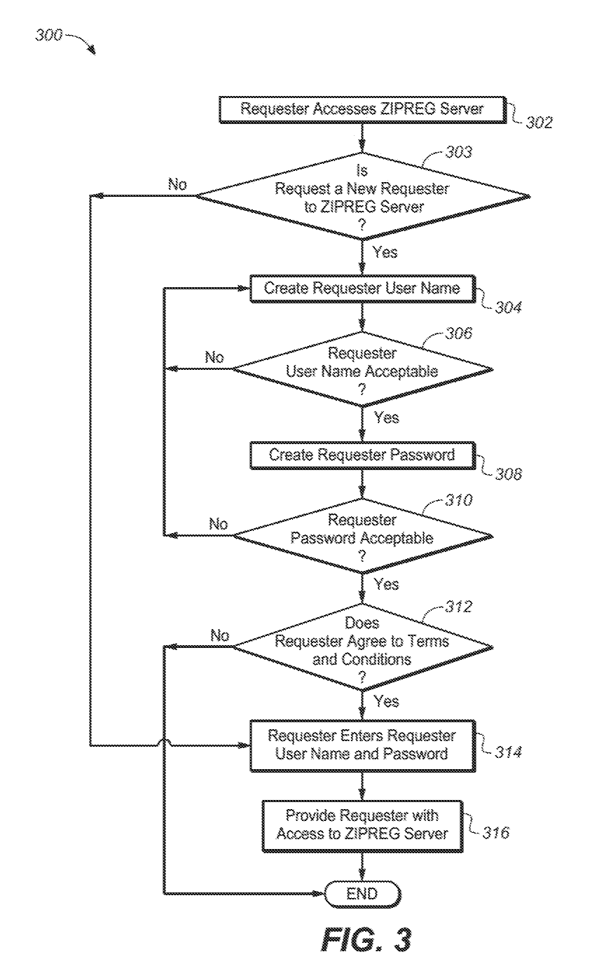

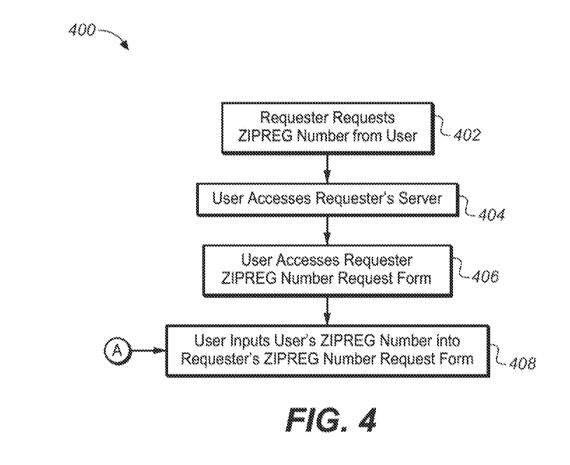

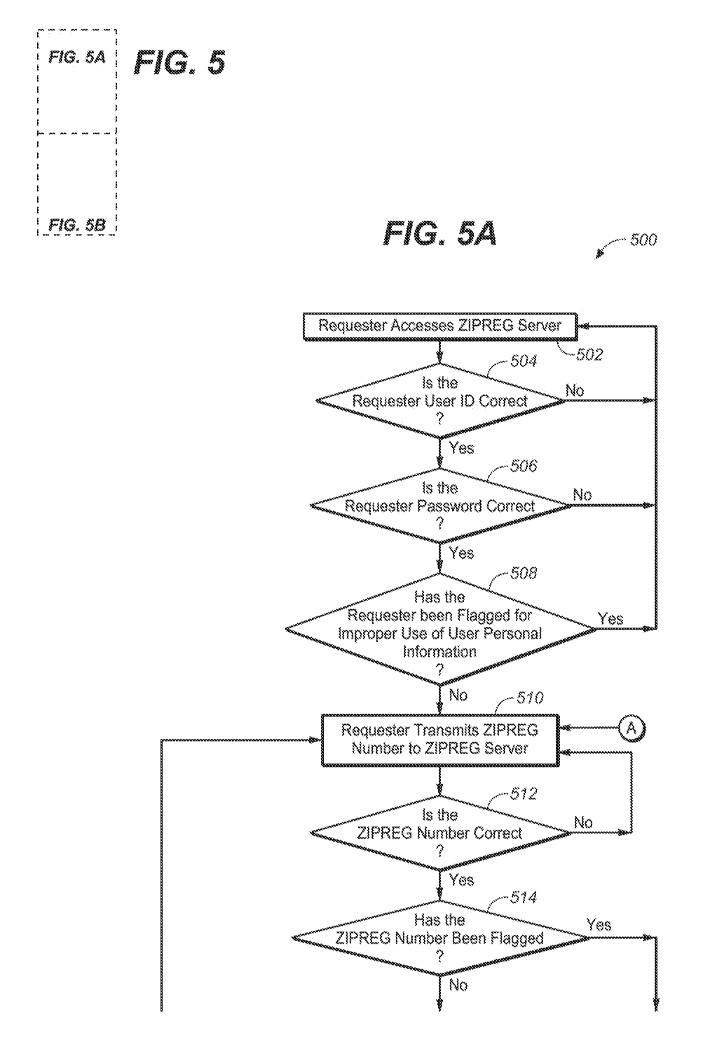

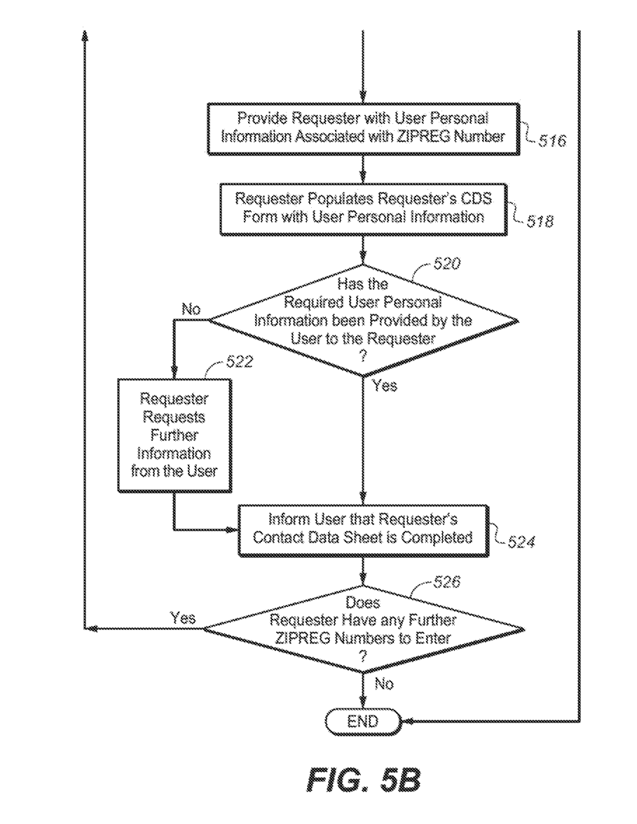

Referring now to the flow charts illustrated in FIGS. 2-5, the various system computer sub-routines for (1) obtaining a user ZIPREG number and editing the user's personal contact detail sheet (CDS) information (200), (2) creating a ZIPREG account by the requester so that the requester is able to access ZIPREG numbers by requester(s) (300), (3) providing ZIPREG number information by the user to the requester (400), and (4) providing user personal CDS information to the requester by utilizing the ZIPREG number (500) will be discussed in greater detail.

As shown in FIG. 2, a sub-routine for obtaining a user ZIPREG number and editing the user's personal contact detail sheet (CDS) information that is executable on the system 2 of FIG. 1 is illustrated. Beginning with step 202, the user logs onto the server 52 of ZIPREG server machine 50 through user input device 14 and browser 6 of user machine 4. Server 52 sends a query to the user asking if the user is a new user, as shown in step 203. If the user has previously set up an account on server 52, the user is then directed to step 212, where the user must enter the user's user identification and user password to access the user's personalized ZIPREG on-line (CDS).

If the user has not previously set up a ZIPREG number account, the user must proceed to step 204, where the user will be asked to enter a user identification which will be reviewed by server 52 for acceptability at step 206 and the user will also be asked to enter a user password (step 208) which will be reviewed by server 52 for acceptability at step 210.

Once the user has set up a ZIPREG account with server 52, the user will then be granted access to the user's personal CDS that is stored in user's personal contact information data storage module 58 (step 212). As shown in step 214, the user will proceed to enter the required amount of personal contact information details as discussed previously with respect to the Example of Personal CDS Information.

With respect to the editing of the CDS information by the use, at step 218, server 52 will ask the user if the personal contact detail information is new personal contact detail information or personal contact detail information that will replace existing personal contact detail information. If the user selects no, meaning that the personal contact detail information is new personal contact detail information, then the new personal contact detail information is saved in step 223. If the user selects yes, meaning that the personal contact detail information is replacing old personal contact detail information, then as shown in step 220, the new personal contact detail information is saved in place of the existing personal contact detail information (step 223).

As shown in step 224, server 52 will review the personal contact detail information entered by the user and determine if the user has entered the minimum required personal contact detail information. If server 52 determines that the personal contact detail information that user has entered is sufficient, then server will forward a ZIPREG number to the user machine 4 so that the user can store the ZIPREG number in ZIPREG number data storage module 10 along with the user's personal contact details information in the user personal contact information data storage module 12. If the personal contact detail information that the user has entered is not deemed to be sufficient, then the user is directed back to step 214 by server 52 where the user is informed as to what type of further personal contact detail information is still needed.

After server 52 sends the ZIPREG number to the user (step 226 and denoted with the letter A), server 52 assigns a unique personal identification number (PIN) to the user's ZIPREG number, as shown in step 228. The PIN is stored in PIN data storage module 60, as shown in step 230. Server then transmits an electronic text or e-mail message to the user so that the user can confirm that, indeed, the user did request a ZIPREG number, as shown in step 231.

Upon receipt of the electronic message from server 52, the user is then prompted to log onto server 52 through browser 6 and confirm that user has requested a ZIPREG number (step 232) and that the user agrees to various terms and conditions regarding the usage of the ZIPREG number (step 234). Once the user has agreed to the requests in steps 232 and 234, the user's CDS is completed and stored in the user's personal contact details information data storage module 58.

In order for the requester to utilize the user's ZIPREG number so that the requester can access the user's personal CDS information, the requester should be required to register as a qualified, secure entity that will adequately protect the safety and privacy of the user's personal contact detail information, as required by the United States Health Insurance Portability and Accountability Act of 1996 (HIPPA), for instance. To assure this occurs, the requester logs onto the server 52 of ZIPREG server machine 50 through browser 103 (step 302). Server 52 sends a query to the requester asking if the requester is a new requester, as shown in step 303. If the requester has previously set up an account on server 52, the requester is then directed to step 314, where the user must enter the requester's requester identification and requester password to gain access to a particular user's personalized ZIPREG on-line contact details sheet (CDS) information stored in user's personal contact information data storage module 58 (step 316).

If the requester has not previously set up a ZIPREG number access account, the requester must proceed to step 304, where the requester will be asked to enter a requester identification which will be reviewed by server 52 for acceptability at step 306 and the requester will also be asked to enter a requester password (step 308) which will be reviewed by server 52 for acceptability at step 310.

As an added measure of security, the requester should also be required to agree to various terms and conditions regarding the usage of the ZIPREG number and the protection of the user's personal contact detail information (step 312).

Once the requester has agreed to abide by the various terms and conditions regarding usage of the ZIPREG number and the user's personal contact detail information, the requester is granted access to server 52 (step 316) after properly logging onto ZIPREG server 52 (step 314). If a user provides the requester with the user's ZIPREG number, the requester then has to log onto the ZIPREG server 52 through browser 103, enter the ZIPREG number and the user's personal contact detail information will be electronically forwarded to the requester, as will be described in greater detail later.

In order for the requester to gain access to the user's personal CDS information, the requester must request the user's ZIPREG number from the user, as shown in step 402. This request can be made in any number of suitable ways, such as, but not limited to, an electronic text message, an e-mail, a telephone call, a hard copy letter or the like. Once the user has received the ZIPREG request from the requester, the user can log onto the requester server 102 through browser 6 (step 404) and access the requester's ZIPREG request form (step 406). The user then can enter the user's ZIPREG number into the proper location on the requester's ZIPREG request form (step 408 and denoted with the letter A).

After the user has provided the requester with the user's ZIPREG number, the requester then must access the ZIPREG server 52 through browser 103 (step 502). The requester will then be asked to enter the requester's requester identification and requester password (steps 504, 506). As part of the overall protection of the user's personal contact detail information, server 52 will then search the requester database module 62 to determine if this particular requester has been flagged or otherwise identified as a security risk (step 508). If the requester has been identified as a security risk, then the session will end. If the requester has not been flagged as a security risk, then the requester transmits the ZIPREG number from the ZIPREG data storage module 108 through browser 103 to the ZIPREG server 52 (step 510 and denoted with the letter A).

Server 52 checks to see if the transmitted ZIPREG number is located in ZIPREG number storage module 56 (step 512). Also, server 52 checks to see if the ZIPREG number has been flagged or otherwise identified for problems such as this particular ZIPREG number may have been used illegally such that the personal contact information may have been improperly disseminated to the public without the user's permission (step 514). If the ZIPREG number has been flagged the session will end. If the ZIPREG number has not been flagged, then server 52 provides the requester with the personal contact detail information from personal contact information data storage module 58 (step 516).

After the user's personal contact detail information has been forwarded to the requester, the requester inputs the user's personal contact detail information into a personal CDS that the requester has created for that particular user (step 518). The requester then checks to see if the required personal contact detail information for that particular user's CDS has been provided by the ZIPREG server 52 (step 520). If there is personal contact detail information that is still needed by the requester, the requester can contact the user in any number of suitable ways, such as, but not limited to, an electronic text message, an e-mail, a telephone call, a hard copy letter or the like to request further personal contact detail information from the user (step 522). If the requester is satisfied that the user's personal contact information is sufficient, then the requester will notify the user that the requester has received the user's personal contact detail information and that the requester's personal CDS has been completed and submitted (step 524).

To complete the process set forth by system 2, the ZIPREG server 52 will ask the requester if the requester has any further ZIPREG numbers to enter (step 526). If the requester has more ZIPREG numbers to enter, the requester is sent back to step 510. If the requester has no further ZIPREG numbers to enter, the session is ended.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of his invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or V” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Also, the present invention can be embodied in any non-transitory computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “non-transitory computer-readable medium” can be any means that can store, communicate, propagate or transport a program for use by or in connection with the instruction-execution system, apparatus or device. The non-transitory computer-readable medium can comprise any one of many physical media such as, for example, electronic, magnetic, optical, electromagnetic, infrared, er semiconductor media but exclude signals, carrier waves, or other transitory signals. More specific examples of a suitable computer-readable medium would include, but are not limited to, a portable magnetic, computer diskette such as floppy diskettes or hard drives, a random access memory (RAM), a read-only memory (ROM), an erasable programmable read-only memory, a portable compact disc or removable flash memory. It is to be understood that the non-transitory computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiments of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies). In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description hereinabove is not intended to limit the invention, except as indicated in the appended claims.

1. A non-transitory system for accessing the full or selected personal detail information of an individual, comprising:
an individual computer means for storing a ZIPREG number, wherein the individual computer data storage means further comprises a means for storing a ZIPREG number and a means for storing the personal contact detail information about the individual;
a ZIPREG computer means for storing personal contact detail information about an individual and for creating and providing the ZIPREG number to the individual;
a requester computer means such that the individual computer means, ZIPREG computer means and requester computer means are operatively connected to each other, wherein the requester computer means further comprises a requester server means, a requester browser means, and a requester computer data storage means such that the requester server means, the requester browser means and requester computer data storage means are operatively connected to each other; and
means for the requester computer means to request the ZIPREG number from the individual computer means in order for the requester computer means to obtain the personal contact detail information about the individual from the ZIPREG computer means.

2. The system, as in claim 1, herein the individual computer means further comprises:
a browser means; and
an individual computer data storage means operatively connected to the browser means.

3. (canceled)

4. The system, as in claim 2, wherein the individual computer means further comprises:
means for inputting information into the individual computer; and
means for displaying information to the individual.

5. The system, as in claim 1, wherein the ZIPREG computer means further comprises:
a ZIPREG server means;
a ZIPREG computer data storage means operatively connected to the ZIPREG server means; and
means for storing information about a requester.

6. The system, as in claim 5, wherein the ZIPREG computer data storage means further comprises:
a means for creating and storing a ZIPREG number;
a means for storing the personal contact detail information about the individual; and
a means for storing a personal identification number that is unique to the individual.

7. (canceled)

8. The system, as in claim 1, wherein the requester computer data storage means further comprises:
a means for storing the ZIPREG number; and
a means for storing the personal contact detail information about the individual.

9. A non-transitory method for accessing the full or selected personal detail information of an individual, comprising:
entering personal contact detail information about an individual into a ZIPREG server in order to create a ZIPREG number that corresponds to the individual's personal contact detail information;
storing the ZIPREG number and the personal contact detail information about the individual in an individual computer means;
providing the ZIPREG number by the individual to a requester; and
allowing the requester to gain access to the personal contact detail information about the individual by utilizing the ZIPREG number.

10. The method, as in claim 9, wherein the step of entering personal contact detail information about an individual in order to create a ZIPREG number that corresponds to the individual's personal contact detail information further comprises:
using a ZIPREG computer means to create a personal contact detail information for the individual;
using the ZIPREG computer means to check the individual's personal contact detail information to determine if the individual's personal contact detail information is substantially sufficient;
using the ZIPREG computer means to provide a ZIPREG number to the individual;
using the ZIPREG computer means to assign a personal identification number to the individual; and
using the ZIPREG computer means to confirm with the individual that the individual has desired to obtain a ZIPREG number.

11. The method, as in claim 10, wherein the step of using a ZIPREG computer means to create a personal contact detail information for an individual further comprises:
using the ZIPREG computer means to create a user name for the individual; and
using the ZIPREG computer means to create a password for the individual.

12. The method, as in claim 10, wherein the step of using a ZIPREG computer means to create a personal contact detail information for an individual further comprises:
means for editing the personal contact detail information for the individual.

13. The method, as in claim 10, wherein the step of using the ZIPREG computer means to confirm with the individual that the individual has desired to obtain a ZIPREG number further comprises:
means for notifying the individual that a ZIPREG number has been established for the individual;
means for the individual to acknowledge that the individual has requested a ZIPREG number; and
means for the individual to accept various terms and conditions for usage of the ZIPREG number.

14. The method, as in claim 9, wherein the step of providing the ZIPREG number by the individual to a requester further comprises:
using a ZIPREG computer means to create a user name for the requester;
using the ZIPREG computer means to create a password for the requester; and
establishing security and information privacy credentials of the requester.

15. The method, as in claim 9, wherein the step of providing the ZIPREG number by the individual to a requester further comprises;
requesting a ZIPREG number from the individual by the requester; and
transmitting the ZIPREG number from the individual to the requester.

16. The method, as in claim 9, wherein the step of allowing the requester to gain access to the personal contact detail information about the individual by utilizing the ZIPREG number further comprises:
transmitting the ZIPREG number from the requester to a ZIPREG server means;
using the ZIPREG server means to authenticate the ZIPREG number; and
transmitting the personal contact detail information of the individual to the requester.

17. At least one non-transitory computer-readable medium storing computer-readable instructions that, when executed by a computing device, cause the computing device to:
enter personal contact detail information about an individual into a ZIPREG server in order to create a ZIPREG number that corresponds to the individual's personal contact detail information;
store the ZIPREG number and the personal contact detail information about the individual in an individual computer means;
provide the ZIPREG number by the individual to a requester; and
allow the requester to gain access to the personal contact detail information about the individual by utilizing the ZIPREG number.

18. The at least one non-transitory computer-readable medium, as in claim 17, wherein the step of entering personal contact detail information about an individual in order to create a ZIPREG number that corresponds to the individual's personal contact detail information further comprises:
using a ZIPREG computer means to create a personal contact detail information for the individual;
using the ZIPREG computer means to check the individual's personal contact detail information to determine if the individual's personal contact detail information is substantially sufficient;
using the ZIPREG computer means to provide a ZIPREG number to the individual;
using the ZIPREG computer means to assign a personal identification number to the individual; and
using the ZIPREG computer means to confirm with the individual that the individual has desired to obtain a ZIPREG number.

19. At least one first non-transitory computing device for controlling utilization of content, the at least one first computing device comprising: one or more processors; and one or more memories operatively coupled to at least one of the one or more processors and having instructions stored thereon that, when executed by at least one of the one or more processors, cause at least one of the one or more processors to:
enter personal contact detail information about an individual into a ZIPREG server in order to create a ZIPREG number that corresponds to the individual's personal contact detail information;
store the ZIPREG number and the personal contact detail information about the individual in an individual computer means;
provide the ZIPREG number by the individual to a requester; and
allow the requester to gain access to the personal contact detail information about the individual by utilizing the ZIPREG number.

20. The at least one first non-transitory computing device for controlling utilization of content, as in claim 19, wherein the step of entering personal contact detail information about an individual in order to create a ZIPREG number that corresponds to the individual's personal contact detail information further comprises:
using a ZIPREG computer means to create a personal contact detail information for the individual;
using the ZIPREG computer means to check the individual's personal contact detail information to determine if the individual's personal contact detail information is substantially sufficient;
using the ZIPREG computer means to provide a ZIPREG number to the individual;
using the ZIPREG computer means to assign a personal identification number to the individual; and
using the ZIPREG computer means to confirm with the individual that the individual has desired to obtain a ZIPREG number.
